(19) United States
(12) Patent Application Publication
(10) Pub. No.: US 2020/0098194 A1
(43) Pub. Date: Mar. 26, 2020

(54) Virtual Reality Anchored Annotation Tool

(71) Applicant: Intuitive Research and Technology Corporation, Huntsville, AL (US)

(72) Inventors: Michael Jones, Athens, AL (US); Kyle Russell, Huntsville, AL (US); Michael Yohe, Meridianville, AL (US); Chanler Crowe, Madison, AL (US)

(21) Appl. No.: 16/191,911

(22) Filed: Nov. 15, 2018

Related U.S. Application Data
(60) Provisional application No. 62/733,769, filed on Sep. 20, 2018.

(51) Int. Cl. G06T 19/20; A63F 13/25

(52) U.S. Cl. CPC G06T 19/20; A63F 13/25; G06F 3/04815; G06T 2219/2004; G06T 2219/2016; G06T 2219/004

(57) ABSTRACT

A method for making annotations on computer-readable media for image annotation allows for the three-dimensional annotation of a three-dimensional Object to be anchored to the same location, rotation, or scale of the annotation relative to the Object in a Virtual Reality, Augmented Reality, or Mixed Reality environment. A user may link an annotation with a three-dimensional Object by creating “ink points” in a Virtual Reality, Augmented Reality, or Mixed Reality environment, which allow for the location, rotation, and scale relationship between the annotation and the Object to be maintained.

### REFERENCE TO RELATED APPLICATIONS

This application claims priority to Provisional Patent Application U.S. Ser. No. 62/733,769, entitled “Virtual Reality Anchored Annotation Tool” and filed on Sep. 20, 2018, which is fully incorporated herein by reference.

### BACKGROUND AND SUMMARY

The disclosed embodiments relate generally to a multi-dimensional computing environment and, more particularly, to image annotation in a multi-dimensional computing environment.

Three-dimensional, virtual worlds provide a number of advantages over the non-virtual world in that they allow greater flexibility in development of training applications leveraging three-dimensional space over non-virtual, traditional computer-based methods with conventional input devices. Computer operators can develop and manipulate objects within virtual worlds in ways not possible in non-virtual environments. The ability to communicate thoughts and ideas within the medium of virtual worlds with various objects is quintessential to increase the efficacy of training, research, and other applications of virtual worlds. The use of three-dimensional virtual worlds to manipulate objects within a software environment will become prevalent in the future as they allow for greater cost efficiency and manipulative ability over the images than non-virtual methods.

Current virtual engines allow for objects to be attached using trees called Parent-child hierarchies, allowing objects to occupy a related space and maintain that relevance mathematically; however, they do not allow for virtual annotation tools that enable the operator to attach the three-dimensional annotation to the three-dimensional object in virtual space and maintain the location, rotation, and scale relationship between the annotation and the Object. The methods described herein allow for anchoring the location, rotation, and scale of the annotation with the location, rotation, and/or scale of the Object.

Presented herein are methods, systems, devices, and computer-readable media for image annotation allowing for the image to be attached to a three-dimensional Object. A three-dimensional Object may be created by an operator selecting the functions within a three-dimensional environment, and an Object may be generated by a system-generation of “ink points”, which link the three-dimensional annotation with the three-dimensional Object selected for annotation. In some embodiments, ink points will be used to maintain the relationship between the three-dimensional Object selected for annotation and the annotation created by the received user input, which may take the form of a highlighted note created by the user. In some embodiments, the annotation tool may draw the annotation in three-dimensional environment and connect that annotation with a three-dimensional Object. The annotation will be kept in the same location, rotation, and scale to the three-dimensional drawing created from the user input.

One embodiment of the tool would be for the operator to select a model representing a real-life analogue within a virtual world. These models can be made up of assemblies and subassemblies to make a system where one or more operators would use the annotation tool to select a system, an assembly, or subassembly to highlight specific characteristics of the object in the virtual world. The use of the annotation could be text, directional arrows, or other descriptive drawing that would serve as the annotation for the selected object. The operator would be able to describe the interfaces represented by the selected object as it relates to other objects. If the object were enlarged or rotated, the accompanying annotation would also be enlarged or rotated in relation to the selected object. The annotation would become a part of the selected object in the virtual world, allowing the annotation to be saved with the object or shared with another user in the same virtual world or another virtual world.

Another embodiment of the tool would be for the operator to select a three-dimensional protein in a virtual world. The operator may then use the annotation tool to select a ligand in the protein. The operator may use the annotation tool to highlight the particular ligand within the protein and use the annotation tool to write an annotation in three-dimensional space. After the three-dimensional annotation is written, the annotation is comprised of “Virtual Ink.” The “Virtual Ink” and the ligand are connected by the Parent-Child hierarchy in location, distance, and size from the selected ligand. If the ligand is then enlarged or rotated, the annotation will also be enlarged or rotated in relation to the atom. The annotation may then be saved or shared with another user in three-dimensional space.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 depicts a system for annotating an Object according to an embodiment of the present disclosure.

FIG. 2 depicts a method for annotating a virtual reality image according to an exemplary embodiment of the present disclosure.

FIG. 3 depicts a method for generating an annotation, according to an exemplary embodiment of the present disclosure.

FIG. 4 illustrates the relationship between three-dimensional assets, the data representing those assets, and the communication between that data and the software, which leads to the representation on the XR platform.

FIG. 5 is a flow diagram describing an example of the process of the graphical tool input generating and orienting the ink points.

FIG. 6 is a flow diagram describing the process of the annotation creation and attachment to the Object.

FIG. 7A is a figure illustrating an example of a virtual three-dimensional Object.

FIG. 7B is a figure illustrating an example of the three-dimensional Object chosen for selection and the selection of an aspect of the object to receive the annotation according to an embodiment of the present disclosure.

FIG. 7C is a figure illustrating an embodiment of a highlighter tool according to an embodiment of the present disclosure.

FIG. 7D is a figure illustrating an example of the highlighter tool making an annotation relating to the selected aspect of the three-dimensional Object according to an embodiment of the present disclosure.

FIG. 7E is a figure illustrating the rotation of the object and the simultaneous rotation of the annotation in relation to the three-dimensional object according to an embodiment of the present disclosure.

### DETAILED DESCRIPTION

In some embodiments of the present disclosure, the operator may use a virtual controller to annotate three-dimensional images. As used herein, the term “XR” is used to describe Virtual Reality, Augmented Reality, or Mixed Reality displays and associated software-based environments. As used herein, “Object” is used to describe a three-dimensional object in a virtual world, including, but not limited to, systems, assemblies, subassemblies, cabling, piping, landscapes, avatars, molecules, proteins, ligands, or chemical compounds. As used herein, “annotation” is used to describe a drawing, text, or highlight used to describe or illuminate the Object to which it is linked.

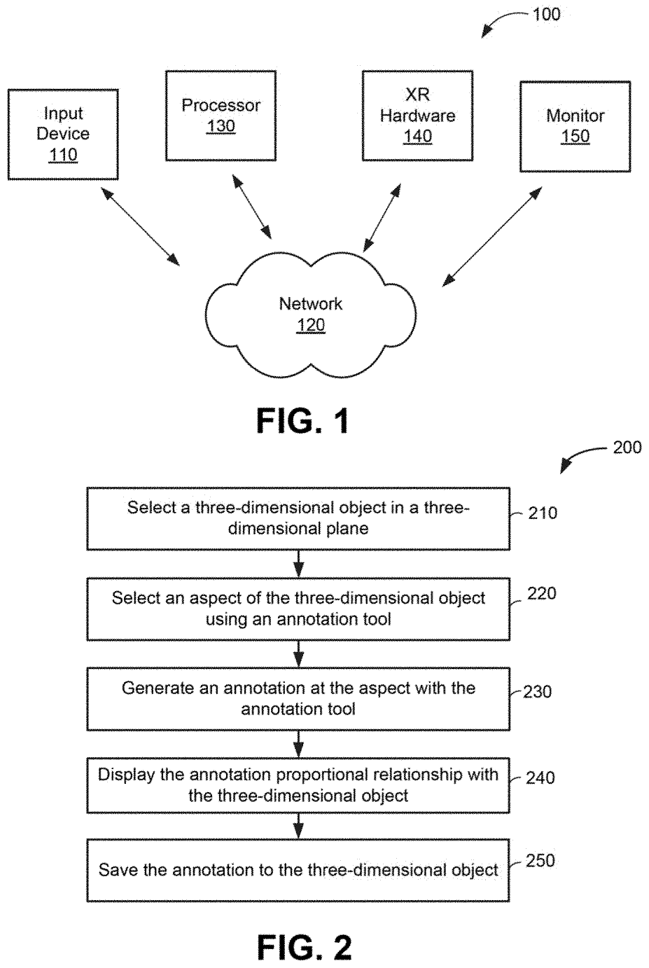

FIG. 1 depicts a system 100 for annotating an Object (not shown), according to an exemplary embodiment of the present disclosure. The system 100 comprises an input device 110 communicating across a network 120 to a processor 130. The input device 110 may comprise, for example, a keyboard, a switch, a mouse, a joystick, a touch pad and/or other type of interface, which can be used to input data from a user (not shown) of the system 100. The network 120 may be of any type network or networks known in the art or future-developed, such as the internet backbone, Ethernet, Wifi, WiMax, and the like. The network 120 may be any combination of hardware, software, or both.

The system 100 further comprises XR hardware 140, which may be virtual or mixed reality hardware that can be used to visualize a three-dimensional world, for example XR headsets, augmented reality headset systems, and augmented reality-based mobile devices, such as tablets and smartphones.

The system 100 further comprises a video monitor 150 is used to display the Object to the user.

In operation of the system 100, the input device 110 receives input from the processor 130 and translates that input into an XR event or function call. The input device 110 allows a user to input data to the system 100, by translating user commands into computer commands.

FIG. 2 depicts a method 200 for annotating an image according to an exemplary embodiment of the present disclosure. In step 210, a user selects a three-dimensional object in a three-dimensional plane. To select the three-dimensional object, the user uses an input device 110 (FIG. 1), for example, a computer mouse. In step, 220, the user selects a particular aspect of the three-dimensional object using an annotation tool (not shown). Although the illustrated method describes step 210 and step 220 as separate steps, in other embodiments the user may select a particular aspect of the object without first selecting the object itself.

In step 230, the user uses the annotation tool to generate an annotation at the aspect. The position and orientation of the annotation tool as actuated by the user determines the annotation. For example, the user may move a mouse to draw freehand text onto the Object. For another example, a three-dimensionally-tracked controller can be used to annotate at the aspect

In step 240, the annotation is displayed and viewed in the same relationship in size and location with respect to the three-dimensional object. This is true regardless of any manipulation performed on the three-dimensional object.

In step 250, the annotation is saved to the three-dimensional object.

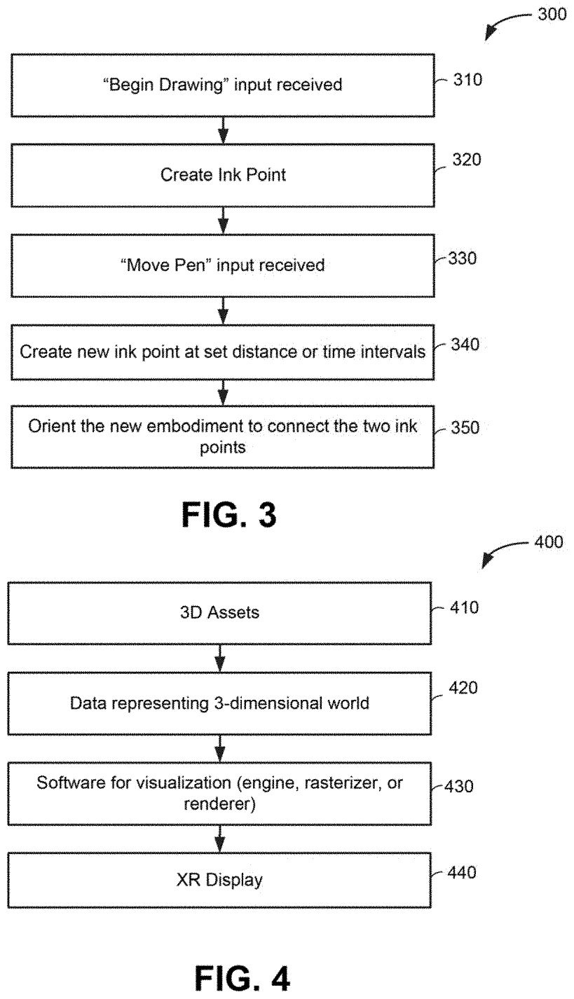

FIG. 3 depicts a method 300 for carrying out the step 230 of FIG. 2, according to an exemplary embodiment of the present disclosure. As discussed above, in step 230, the user uses the annotation tool to generate an annotation at the aspect of the object. In the method 300, virtual ink points are created using the annotation tool, as discussed herein.

In step 310, the input device 110 (FIG. 1) receives information from the user that signals the processor 130 to begin the creation of an annotation (drawing). In step 320, the virtual ink points (not shown) are created. An ink point is a point in space that defines an origin of a mesh, or a point along a spline, for use with a spline point, particle trail, mesh, or other representation of ink or drawing/painting medium.

In step 330, the processor 130 (FIG. 1) receives information from the input device 110 (based on the user controlling the input device) to move the annotation tool to a new position/orientation. In step 340, as the input device 110 sends input to move the annotation tool, new ink points are created at set distance and relational intervals. The processor 130 receives this input and creates additional ink points as the “Move Pen” input continues. In step 350, the processor 130 orients and connects the additional ink points.

FIG. 4 illustrates the relationship between three-dimensional assets, the data representing those assets, and the communication between that data and the software, which leads to the representation on the XR platform. Three dimensional assets 410 may be any three-dimensional assets, which are any set of points that define geometry in three-dimensional space. The data representing a three-dimensional world 420 is a three-dimensional mesh that may be generated by importing three dimensional models, images representing two-dimensional data, or other data converted into a three-dimensional format. The software for visualization 430 of the data representing a three-dimensional world 420 allows for the processor 130 (FIG. 1) to facilitate the visualization of the data representing a three-dimensional world 420 to be depicted as three-dimensional assets 410 in the XR display 440.

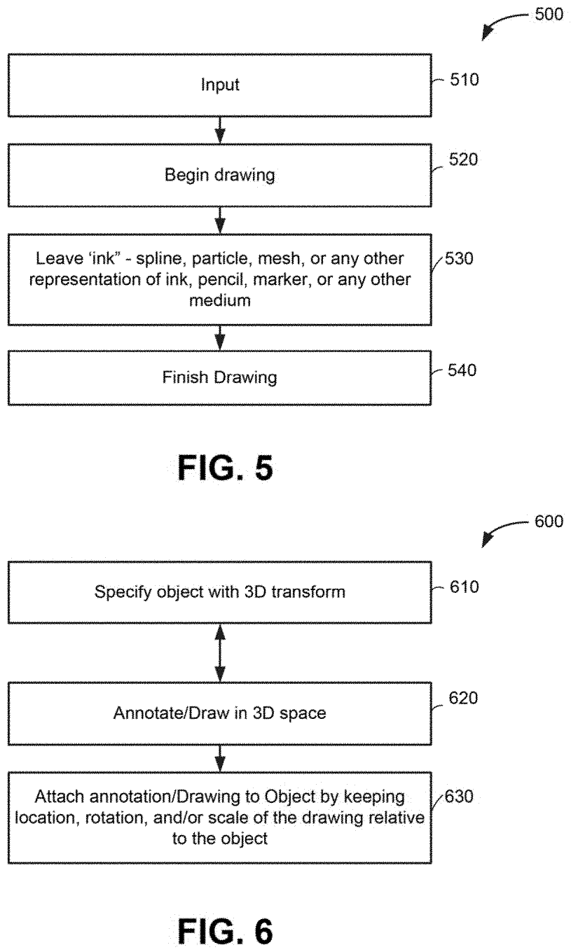

FIG. 5 depicts an exemplary three-dimensional annotation/drawing tool input flow 500, which allows for the processor to receive input from the controller. In step 510, input is created as the user begins drawing 620, which will provide the input device 110 (FIG. 1) and the processor 130 will cause the pen to “move” in three-dimensional space to a new position with input that it will send to the processor 130. After the input is received, the drawing is begun in step 620, which begins the creation of ink points 220 in step 530 (FIG. 5). An ink point is a point in space that defines the origin of a mesh, or a point along a spline, for use with a spline point, particle trail, mesh, or other representation of ink or drawing medium. As the ink points are created “move pen” input is received, the ink points are left in the medium, which will create an ink trail by leaving multiple ink points at fixed distance and time intervals from the previous ink point. The ink points may be a set of splines, particles, a mesh, or any other three-dimensional asset that could represent ink, in some embodiments. In other embodiments of the process described herein, the “Virtual Ink” may be paint, pencil, marker, highlighter, or any other ink-like medium. The user may then use the input device 110 to send input 510 (FIG. 5) through the processor 130 to signal to finish the drawing, which will cease the input flow 510 and stop the creation of ink point. One embodiment of the method described would then ensure the embodiment is oriented so that the asset implies the direction the pen was moving. In step 540, the user may then conclude the drawing by signaling the input device 110 to stop sending input, which sends a message to the processor 130 to finish drawing 540.

FIG. 6 depicts a method 600 for concluding the three-dimensional annotation/drawing that will associate the annotation with a three-dimensional Object. Once the annotation is drawn, it will maintain the same relationship with the Object, relative to the distance, location, or scale that the annotation and the Object shared when the annotation was created. When the first “ink point is created in relation to the Object, the rasterizing software recognizes the “ink point” as the Object's child and the Object as the “ink point's” parent. As “ink points” are created, they are stored in a Spline Mesh Component, which contains only the child points. In this embodiment, the parent and children maintain the same relationship in location, orientation, and scale because the parent and children are attached within the software by a mathematical equation (known in the game industry) that multiplies the location of each linked child by the previous child, until reaching the parent Object. Each consecutive “ink point” is linked to the “ink point” before it, until the parent Object is reached, like a chain. In this regard, the ink points are stored in a “spline mesh component” that is the child of the parent Object. Points that are stored within that component are only related to the component, and not to the parent.

As depicted in FIG. 6, this relationship can be created using multiple methods. First, by selecting the three-dimensional Object as described in 610, then performing the annotation 620, the processor 130 (FIG. 1), will then attach the annotation to the three-dimensional asset 630. Alternatively, the annotation can be created first 620, then the three-dimensional Object selected 610 and linked to the previously created annotation 630. FIG. 6 depicts one embodiment of the user specifying which object will be annotated. In the present disclosure, the method will then use mathematics, such as three-dimensional transforms, or the constructs offered by the user's rasterizing software to keep the location, orientation, or scale of the finalized annotation relative to the previously defined Object.

Further, standard constructs of game engine and game development are used to specify objects in the virtual world. This could be based on a collision that takes place between the user's hand, for example, and the object to be selected. Or, alternatively, other ways can be used to specify which object to select. The 3D transform specifies the location of the object, its orientation, and its scale, and provides the basis for the calculations used to attach the ink.

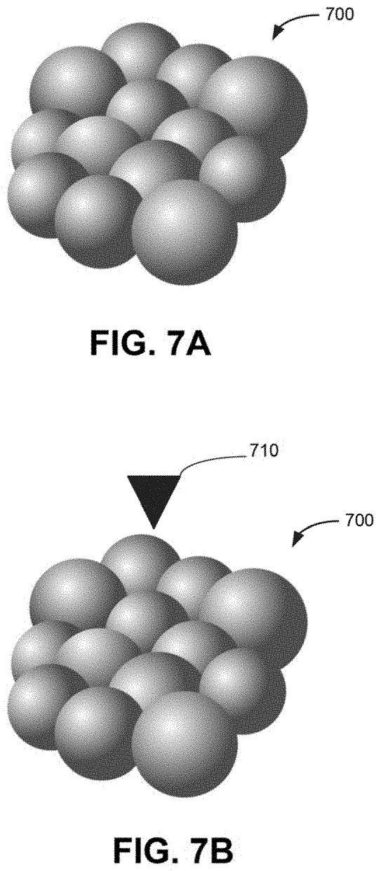

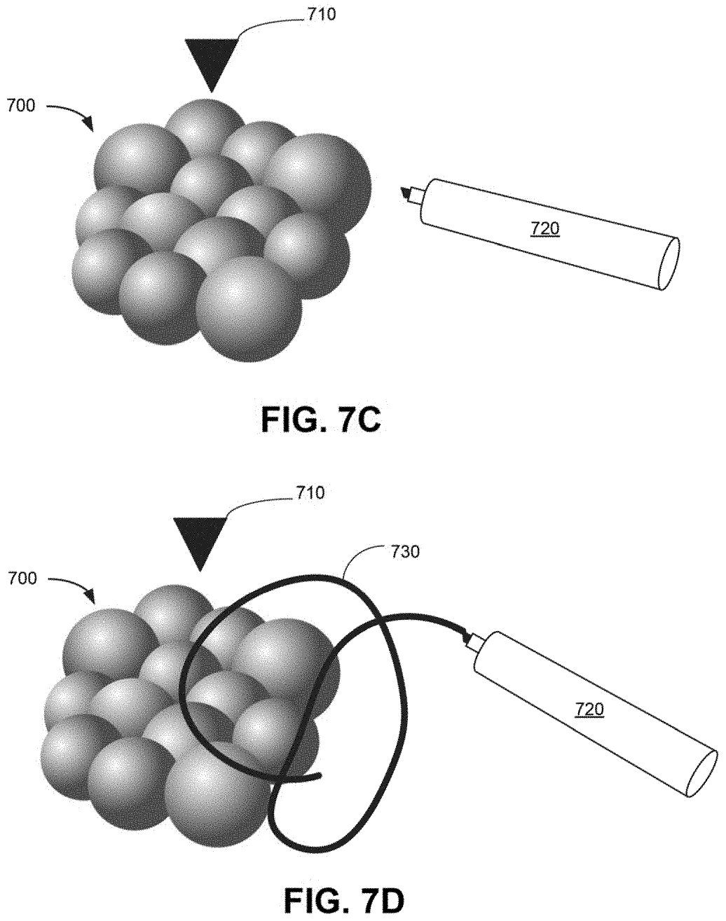

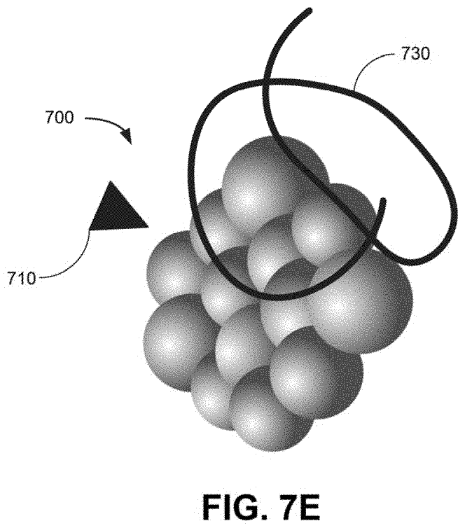

FIG. 7A depicts an Object 700 being visualized in three-dimensional space. The object may be Instanced Static Mesh, a Particle, a billboard, a static mesh, a skeletal mesh, or any other method to represent three-dimensional assets. In this exemplary figure, the mesh is instanced static mesh. In other examples, the object could be a particle, a billboard, a static mesh, a skeletal mesh, or another method used to represent 3D assets.

FIG. 7B depicts the selection of an aspect 710 of that Object 700 of note for annotation. FIG. 7C depicts an image of a virtual highlighter 720 that is the annotation tool in this example. Alternatively, the tool used could be representative of any tool related to writing, drawing, painting, or transferring “Virtual Ink” from user input to visualization.

FIG. 7D illustrates a “Virtual Ink” trail represented by a streak 730 on the object 700. Alternatively, the “Virtual Ink” may be represented by splines, particles, meshes, or other visualization techniques. Either before, during, or after creation, the pen streak 730 is associated with the object, according to the methods described herein.

FIG. 7E demonstrates that the XR annotation 730 rotates with the Object 700, after the XR annotation has been created. In this figure, the Object 700 has been rotated about 90 degrees counter-clockwise, and the XR annotation 730 made by the highlighter Tool has moved with the Object in the same relation to the Object.

What is claimed is:

1. A method for image annotation, comprising:
selecting a three-dimensional object in a three-dimensional plane;
selecting an aspect of the three-dimensional object;
generating an annotation at the aspect with an annotation tool;
displaying the annotation in the same relationship in size and location to the three-dimensional object, regardless of any manipulation that the three-dimensional object is subsequently subjected to; and
saving the annotation to the three-dimensional object.

2. The method of claim 1, wherein the step of selecting an aspect of the three-dimensional object is performed using the annotation tool.

3. The method of claim 1, wherein the step of generating an annotation at the aspect with the annotation tool further comprises creating a first ink point at a first point within the three-dimensional plane.

4. The method of claim 3, wherein the step of generating an annotation at the aspect with the annotation tool further comprises creating a second ink point at a second point within the three-dimensional plane, the second ink point associated with the first ink point.

5. The method of claim 4, wherein the step of generating an annotation at the aspect with the annotation tool further comprises creating subsequent ink points at subsequent points within the three-dimensional plane, the subsequent ink points associated with the first ink point and second ink point.

6. The method of claim 5, wherein the first ink point, the second ink point, and the subsequent ink points together form the annotation.

7. The method of claim 2, wherein the step of generating an annotation at the aspect with the annotation tool based on the position and orientation the object using the tool further comprises applying virtual ink in a chain in virtual reality.

8. The method of claim 1, wherein the step of displaying the annotation in the same relationship in size and location to the three-dimensional object comprises displaying to third parties in multi-player programs.

9. A method for image annotation, comprising:
generating an annotation on a three-dimensional object in a three-dimensional plane using a virtual annotation tool;
associating the annotation to the three-dimensional object and displaying the annotation such that when the three-dimensional object is moved or manipulated, the annotation maintains a proportional relationship in size and location to the three-dimensional object same relationship in size and location to the three-dimensional object.

10. The method of claim 9, further comprising selecting the three-dimensional object to be annotated.

11. The method of claim 10, further comprising selecting an aspect of the three-dimensional object.

12. The method of claim 11, further comprising saving the annotation to the three-dimensional object.

13. The method of claim 9, wherein the step of generating an annotation on a three-dimensional object in a three-dimensional plane using a virtual annotation tool further comprises creating a first ink point at a first point within the three-dimensional plane.

14. The method of claim 13, wherein the step of generating an annotation at the aspect with the annotation tool further comprises creating a second ink point at a second point within the three-dimensional plane, the second ink point associated with the first ink point.

15. The method of claim 14, wherein the step of generating an annotation at the aspect with the annotation tool further comprises creating subsequent ink points at subsequent points within the three-dimensional plane, the subsequent ink points associated with the first ink point and second ink point.

16. The method of claim 15, wherein the first ink point, the second ink point, and the subsequent ink points together form the annotation.

17. The method of claim 9, wherein the step of generating an annotation on a three-dimensional object in a three-dimensional plane using a virtual annotation tool further comprises applying virtual ink in a chain in virtual reality.

18. The method of claim 9, wherein the step of associating the annotation to the three-dimensional object and displaying the annotation further comprises displaying to third parties in multi-player programs.

19. A method for image annotation, comprising:
selecting an aspect of a three-dimensional object in a three-dimensional plane;
generating an annotation at the aspect with an annotation tool;
displaying the annotation in the same relationship in size and location to the three-dimensional object, regardless of any manipulation that the three-dimensional object is subsequently subjected to; and
saving the annotation to the three-dimensional object.

20. The method of claim 19, wherein the step of selecting an aspect of the three-dimensional object is performed using the annotation tool.
